(19) United States
(12) Patent Application Publication
(10) Pub. No.: US 2013/0026732 A1
(43) Pub. Date: Jan. 31, 2013

(54) DOUBLE BRIDGE BICYCLE FORK

(71) Applicants: Wolfgang Kohl, Schwabach (DE); Vincenz Thoma, Koblenz (DE); Lutz Scheffer, Garmisch-Partenkirchen (DE)

(72) Inventors: Wolfgang Kohl, Schwabach (DE); Vincenz Thoma, Koblenz (DE); Lutz Scheffer, Garmisch-Partenkirchen (DE)

(73) Assignee: Canyon Bicycles GmbH

(21) Appl. No.: 13/552,102

(22) Filed: Jul. 18, 2012

(30) Foreign Application Priority Data
Jul. 29, 2011 (DE) 202011103814.2

(51) Int. Cl. B62K 21/02

(52) U.S. Cl. 280/280

(57) ABSTRACT

A double bridge bicycle fork with integrated brake unit, suited especially for racing bicycles and time-trial machines, comprises two fork legs connected by a fork crown. Further, a bottom bearing seat is connected with the fork crown. A steer tube is provided in front of the rotational axis of the fork, seen in the direction of travel, said axis being defined by the bottom bearing seat and the upper bearing seat. The steer tube is connected with the stem by means of screws. This makes it possible not to provide a rigid head tube between the two bearing seats, but to arrange a sleeve in the embodiment illustrated that has an opening for passing actuation elements therethrough, such as switching or brake cables.

### CROSS REFERENCE TO RELATED APPLICATIONS

The present disclosure claims the priority of German Utility Model Application no. DE 20 2011 103 814.2 filed on Jul. 29, 2011, the disclosures of which are incorporated herein by reference.

### BACKGROUND

1. Field of the Disclosure

The disclosure refers to a double bridge bicycle fork in particular for racing bicycles, most preferably for use with time-trial machines.

2. Description of the Prior Art

With racing bicycles, and in particular with time-trial machines, aerodynamics is essential. Bicycle manufacturers are therefore interested in placing cables and lines inside the frame, as far as possible, so as to improve aerodynamics. It is known to lead the cables for the front and rear derailleurs, as well as for the rear wheel brake, from the handlebar laterally past the head tube and to introduce it into the down tube of the bicycle frame from below or from the side. Although this may already improve the aerodynamics, the cables guided laterally past the head tube still cause turbulences and, as a result thereof, negatively affect the aerodynamics. Further, in the interest of enhancing aerodynamics, attempts to changes in the arrangement and the design of the front wheel brake are made, since a front wheel brake arranged in front of the double bridge bicycle fork, seen in the direction of travel, causes substantial air turbulences and thereby strongly affects the aerodynamics. It is known to arrange the front wheel brake on the rear—seen in the direction of travel—of the fork crown or fork bridge connecting the two fork legs. Thereby, a certain enhancement of the aerodynamics can be achieved, since the front wheel brake is not directly flown against by the airflow. However, also in this case, substantial turbulences occur. Further, such brake arrangements have a drawback in that the brake cable is arranged laterally of the head tube of the frame and thereby also contributes to a deterioration of the aerodynamics.

Further, time-trial machines use so-called double bridge forks. Such a fork has a fork crown connecting the two fork legs, the fork crown carrying a lower bearing seat, such as a pivot bolt. The steer tube is arranged in front of the fork crown, seen in the travelling direction. Thus, the steer tube is arranged in front of the head tube of the bicycle frame. The upper steering bearing is supported by another component. This component is connected with the steer tube through the head tube of the frame and further represents the connection to the handlebar in the manner of a stem. Both steering bearings are connected through a solid, highly rigid threaded rod and are tightened against each other. This continuous head tube arranged between both steering bearings helps to realize the necessary rigidity.

### SUMMARY OF THE DISCLOSURE

It is an object of the disclosure to provide a double bridge bicycle fork with which aerodynamics can be enhanced.

The double bridge bicycle fork of the present disclosure which has been developed in particular for racing bicycles and more preferably for time-trial machines comprises two fork legs connected by a fork crown. The fork crown is connected with a bottom bearing seat, which is designed in particular as a pivot bolt. The bearing seat preferably is of the type inserted from below into the head tube of a bicycle frame, while not passing completely through the head tube, so that no direct connection between the bottom bearing seat and the upper bearing seat has to be provided. In particular, if a corresponding sleeve-like connection between the upper and the bottom bearing seats is provided at all, the same must absorb no or only a small portion of the forces to be transmitted. With the double bridge bicycle fork of the present disclosure, the absorption and transmission of force is effected via the steer tube arranged offset from or, seen in the traveling direction, in front of the head tube of the bicycle frame housing the bearing elements. This offers the advantage, which is essential to the disclosure, that actuation elements such as cables, hydraulic lines, electric lines and the like can be inserted into the adjoining frame element from a region between the two bearing seats or between the two bearings, respectively. Thus, according to the disclosure, such actuation elements, which may be switching elements for the front or the rear derailleur or operation or actuation elements for the rear wheel brake, can be passed rearward from the region between the two bearings of the head tube.

Thus, corresponding actuation elements do not have to be introduced into the down tube from the side or from below. Thereby, the occurrence of turbulences in this region is avoided. It is particularly preferred that the actuation elements are introduced from the handle bar directly into the component forming the stem and from there through the upper bearing into the head tube. From the same, the actuation elements are passed into the adjacent frame element. Before the operation or actuation elements are passed rearward into the frame between the two bearings of the head tube, they can thus be passed either through the stem from above or directly from the handle bar through the inside of the stem. It is also possible that only some actuation elements, e.g. the shift cables, extend in the handle bar and within the stem, while the brake cable is introduced into the stem from above.

It is further preferred that the corresponding actuation elements are already arranged inside the handle bar. This has the advantage, essential to the disclosure, that corresponding actuation elements are completely arranged inside bicycle components (handle bar, stem and frame). With a correspondingly designed double bridge bicycle fork, for example, the corresponding actuation elements do not exit the frame or only in an aerodynamically non-critical region. Depending on the possible configuration of the derailleurs, this is also applicable to them.

The bottom part of the steer tube, which is preferably fixedly connected with the fork crown and also with the bottom bearing seat, is further fixedly connected with the stem or a stem forming the upper part of the steer tube. In particular, the connection is made by threading, the stem or a projection rigidly connected with the stem forming the upper bearing seat so that the threading allows to realize a pre-tensioning of the bearings.

In a particularly preferred embodiment the upper bearing seat is connected to a sleeve, especially in the interest of a simplification of assembly. The sleeve preferably projects throughout the head tube and is also connected with the lower bearing seat, wherein preferably no or at least no substantial forces are transmitted via the sleeve. The sleeve has an opening facing to the frame element, the opening being provided for passing the actuation elements therethrough.

In a preferred embodiment of the disclosure a cable stop is connected in particular with the sleeve. A corresponding cable stop may also be connected with the upper or the bottom bearing seat. It is the purpose of the cable stop to allow, e.g. if a Bowden cable is provided, that the outer sheath of the Bowden cable only extends from the switch lever to the cable stop, for instance, while the Bowden cable itself extends inside the frame without a sheath. Thereby, it is possible to keep the cable under constant tension inside the frame so that a rattling or beating of the frame is avoided.

In order to arrange a brake unit of a particularly preferred embodiment of the disclosure below or at least partly inside the fork crown, an actuation element for the brake, such as a Bowden cable or the like, is passed through the bottom bearing seat or the bottom bearing element arranged in the bearing seat. The actuation element, which may be a hydraulic line or also an electric line instead of a cable, is thus lead to the brake unit substantially from above. This has the advantage that the actuation element is arranged inside the frame at least in this region and that it is not necessary to introduce a Bowden cable or another actuation element from outside and laterally to the brake unit. Thereby, the aerodynamics of the bicycle can be enhanced further, since no actuation element that could cause turbulences, such as a Bowden cable, is arranged in the airflow. Here, it is particularly preferred that the actuation element is passed from the brake arm arranged on the handle bar preferably directly through the stem and then, according to a particularly preferred embodiment, through both the upper and the bottom bearing seat. Here, the two bearing seats may be connected with a head tube, in particular of rigid design, the head tube pre-tensioning in particular the two bearing elements arranged in the bearing seats.

The brake unit preferably comprises two brake arms arranged within the fork legs and/or the fork crown. Preferably, the brake arms are partly arranged in the upper portion of the fork legs directed toward the fork crown and partly within the fork crown. In a preferred embodiment, the brake arms do not protrude from the double bridge bicycle fork so that an aerodynamically optimized outer surface of the fork can be realized.

Preferably, the brake arms are pivotable brake arms whose pivot axis is also arranged in within the two fork legs and/or the fork crown. In a preferred embodiment, the two pivot levers are arranged in one plane so that the two brake jaws supported by the lower ends of the brake arms are arranged exactly opposite each other and, in particular, the forces transmitted onto the brake jaws lie opposite each other in a plane arranged perpendicularly to the longitudinal direction or perpendicularly to the central plane of the front wheel. In a preferred embodiment also the two free brake arm ends, i.e. the ends of the brake arms that carry no brake jaws, are arranged opposite each other. In particular, the two brake arms do not cross each other.

Here, the pivot axes may be arranged above the ends carrying the brake jaws so that the brake is actuated by pressing apart the two upper free ends of the brake arms. It is also possible to arrange the pivot axes below the brake jaws, which would then be arranged in an intermediate part of the brake arms, so that the brake is actuated by pressing the two upper free ends of the brake arms together.

The two brake arms are preferably actuated by a common actuation means. The actuation means will be described hereunder with reference to a brake unit wherein the pivot axes are arranged above the free ends carrying the brake jaws. A correspondingly designed actuation element may of course also be provided in a brake unit where the pivot axes are arranged below the brake jaws.

In a preferred embodiment the brake unit is therefore arranged between the two free brake arm ends. The actuation means preferably comprises at least one actuation element acting on the brake arm ends. For instance, it is possible that the two brake arm ends extend obliquely or are directed toward each other. A, for example, trapezoidal or triangular actuation element may be arranged between the two brake arm ends. By displacing or pulling such an actuation element upward, the two free ends of the brake arm ends are pressed apart. Since they are supported by the pivot axes, the two brake jaws are moved towards each other and are pressed against the rim.

In a particularly preferred embodiment of the actuation means the same comprises two actuation elements. The two actuation elements, which are preferably actuated through a common brake cable or a common hydraulic line, are preferably designed as pivot levers. The pivot levers which are in particular fixed to a holder element, are pivoted, in particular together, by actuation of the brake cable or by application of hydraulic force. The pivot levers apply a force on the free ends of the brake arm ends, whereby the same are pressed apart. This, in turn, causes the two brake jaws to move towards each other.

The two actuation elements, preferably designed as pivot levers, are pivotably fixed on a holding element such that actuating the pivot levers will pivot the outward in opposite directions for braking. In particular, the holding element is arranged, in particular fixed, within the fork crown. In a preferred development, the holding element preferably comprises two lateral surfaces designed as abutment surfaces for the brake arm ends. In the open state of the brake the brake arms can abut against these surfaces.

For an enhancement of the aerodynamics, the disclosure provides that the actuation element for the front wheel brake should preferably be arranged within the frame, like the brake cable or a corresponding hydraulic line. In this case, it is preferred that the brake cable is passed through the fork crown and the bottom bearing seat. From there, the brake cable reaches the head tube of the frame from where it may be lead through the upper bearing seat and the component supporting the handle bar to the brake handle fastened on the handle bar. Further, it is preferred that the bearing seat, in particular designed as a bearing pivot, is closed at the top so that the top of the bearing seat can be used as a cable stop for the brake cable. Thus, the cable, including the sheath, can be passed through the head tube and the sheath terminates at the cable stop. Below the cable stop, the cable extends freely, i.e. without a sheath, to the actuation element the brake unit.

In a particularly preferred embodiment of the present double bridge bicycle fork with a brake unit, it is possible to design the same such that the cross section of the fork leg has a length-to-width ratio at the level of the tire of at most 3:1. In this respect, the present double bridge bicycle fork with brake unit also meets the strict rules of the UCI, i.e. the International Cycling Union.

### BRIEF DESCRIPTION OF THE DRAWINGS

A full and enabling disclosure of the present disclosure including the best mode thereof, enabling one of ordinary skill in the art to carry out the disclosure, is set forth in greater detail in the following description, including reference to the accompanying drawing in which

FIG. 1 is a schematic, partly sectional vie of a bicycle frame in the region of the head tube together with the double bridge bicycle fork of the present disclosure,

FIG. 2 is a schematic side elevational view of the double bride bicycle fork in the region of the fork crown, and

FIG. 3 is a schematic sectional rear view of the double bridge bicycle fork of the present disclosure.

### DESCRIPTION OF PREFERRED EMBODIMENTS

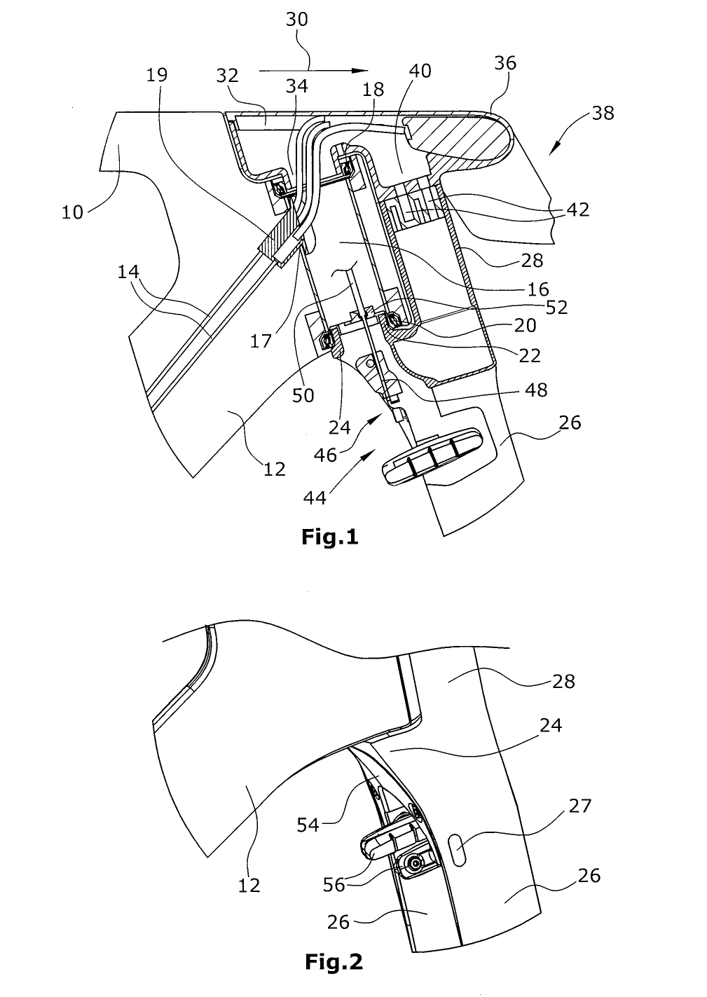

FIG. 1 schematically illustrates a detail of a time-trial machine. A top tube 10 is shown that is connected with a down tube 12, with switching cables 14 being arranged in the down tube 12. An upper bearing 18 and a lower bearing 20 are arranged in a head tube 16. The lower bearing 20 is supported by a bearing seat 22 formed as a bearing pivot. In the embodiment illustrated, the bearing seat 22 is formed as one piece with a fork crown 24. The fork crown 24 connects the two fork legs 26, the fork in particular being a fork made from a composite material, especially a fork reinforced with glass fibers, so that the fork crown 24 and the fork legs 26 are also formed integrally. Moreover, the fork comprises a steer tube 28 arranged in front of the head tube 16, seen in the direction of travel, and thus offset from the fork crown 24.

An upper component 32 comprises a bearing seat 34, also in the form of a pivot, for receiving the upper bearing 18, and thereby forming the stem. Further, the component 32 has a projection 36 that supports a bicycle handle bar 38, i.e. a triathlon handle bar in the embodiment illustrated. A projection 40, directed towards the steer tube 28, is provided between the bearing seat 34 and the projection 36. The projection 40 is connected to the steer tube 28 by means of screws 42. Forces are not or only to a negligible extent transmitted via the head tube 16, but via the steer tube 28 and the projection 40 of the stem 32 connected with the steer tube 28 by means of said screws 42. Thereby, it is possible to provide an opening 17 in the sleeve-shaped head tube 16. An actuation element, such as a switch or brake cable 14, is guided through the opening 17 into the inside of the head tube 16. The cables 14, which may of course also be electrical lines, hydraulic lines or the like, are passed from the head tube 16 through the bearing seat 34 of the upper bearing 18 into the stem 32 and from there to corresponding portions of the handle bar 38. The actuation elements 14 are thus arranged completely within the corresponding components and leave the lower frame tube for example only in the region of the front derailleur. Thereby, the aerodynamics of the bicycle is substantially enhanced, since no turbulences occur that would be caused by outside actuation elements.

In the embodiment illustrated a cable stop 19 is arranged in the opening 17 of the sleeve 16. The cable stop 19 is designed such that, if Bowden cables are provided as the actuation elements 14, the sheaths of the Bowden cables end in the cable stop 19 and thus, only the corresponding metal wires are arranged in the down tube 12. The same may be kept taut so that rattling and beating are avoided.

Below the fork crown 24, a brake unit 44 is arranged that is integrated in the fork legs 26 and the fork crown 24. The brake unit 44 comprises an actuation means 46 to be operated through a Bowden cable 48. The Bowden cable 48 extends through the fork crown 24 and the bearing seat 22 into the inside of the head tube 16. The Bowden cable 48 further extends through the upper bearing 18 and from there to the handle bar 38 or the brake. The bearing seat 22 is closed at the top so that a sheath 50 of the Bowden cable 48 is arranged only within the head tube and extends up to the brake lever. The sheath 50 is retained in a cylindrical cable end stop 52 which is preferably formed integrally with the bearing seat 22.

According to the disclosure, the brake unit 44 is preferably arrange below a rotational axis of the fork, the rotational axis substantially coinciding with the sheath 50 within the head tube 16 in the embodiment illustrated.

In the assembled state (FIG. 2), the rear side of the fork legs 26, as well as of the fork crown 24, is closed with a cover element 54. As such, only the two brake jaws 56 are visible in the final assembled state of the brake unit 44.

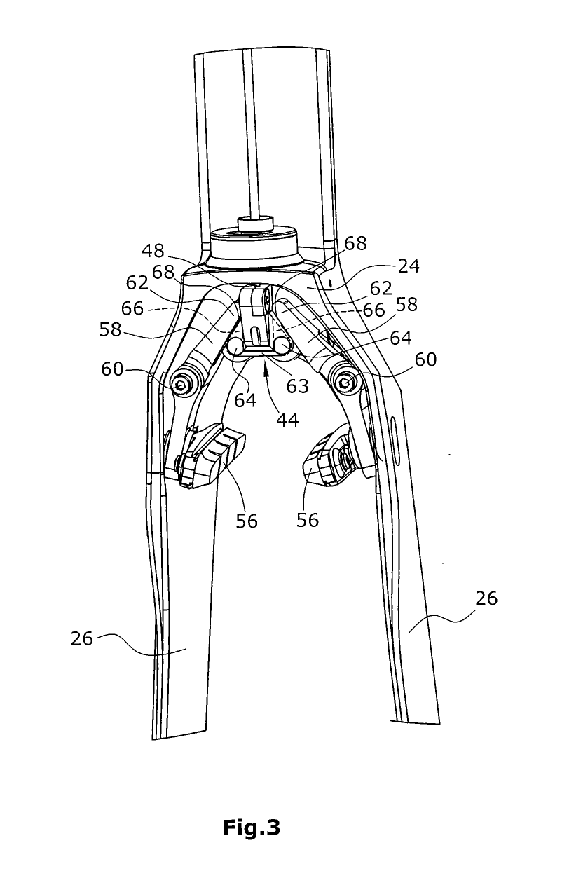

The double bridge bicycle fork of the present disclosure comprises two brake arms 58 (FIG. 3) arranged within the fork legs 26 and the fork crown 24. The two brake arms are supported for pivotal movement by pivot axes 60, the pivot axes 60 also being arranged within the fork legs 26 and the fork crown 24. When, for braking, the two free brake arm ends 62 are pressed apart out of the position illustrated in FIG. 3, in which no braking takes place, the two brake jaws 56 are moved inward towards the rim (not illustrated). The actuation means 44 is provided in order to realize this pivoting of the brake arms 58. Said means comprises a holding element 63 arranged within the fork crown. The holding element 63 carries two pivot axes 64 about which two pivot levers 66 may be pivoted, said levers being arranged within the holding element and being illustrated in dotted lines in FIG. 3. The pivot levers 66 are connected with the brake cable 48. By pulling the brake cable 48 upward in FIG. 3, the two pivot levers 66 are pivoted outward. Thereby, the free ends 62 of the brake arms 58 are pressed outward which, in turn, causes a movement of the two brake jaws inward towards the rims.

The holding element 63 of substantially trapezoidal shape, seen in top plan view, comprises two obliquely arranged lateral surfaces 68 against which the free ends of the brake arms 58 abut when the brake is not actuated.

Although the disclosure has been described and illustrated with reference to specific illustrative embodiments thereof, it is not intended that the disclosure be limited to those illustrative embodiments. Those skilled in the art will recognize that variations and modifications can be made without departing from the true scope of the disclosure as defined by the claims that follow. It is therefore intended to include within the disclosure all such variations and modifications as fall within the scope of the appended claims and equivalents thereof.

What is claimed is:

1. A double bridge bicycle fork, in particular for racing bicycles, comprising:
a fork crown connecting two fork legs,
a bottom bearing seat connected with said fork crown,
an upper bearing support connected with a stem,
a steer tube offset from the fork crown, said steer tube connecting said two bearing seats, and
actuation elements for switching elements and/or a rear wheel brake, said actuation elements being guided from a handle bar connected with said stem, passing between said two bearing seats, into a frame element.

2. The double bridge bicycle fork of claim 1, wherein the steer tube is fixedly connected with the stem, in particular screwed thereto.

3. The double bridge bicycle fork of claim 1, wherein the actuation elements are passed through the upper bearing seat.

4. The double bridge bicycle fork of claim 1, further comprising a sleeve connected with the upper bearing seat, which has an opening directed towards the frame element and intended for passing the actuation elements therethrough.

5. The double bridge bicycle fork of claim 1, wherein the sleeve is connected with the bottom bearing seat.

6. The double bridge bicycle fork of claim 1, further comprising a cable stop connected with the upper bearing seat, in particular with the sleeve.

7. The double bridge bicycle fork of claim 1, wherein said actuation elements are arranged within the handle bar and preferably within the stem.

8. The double bridge bicycle fork of claim 1, further comprising a brake unit integrated in the bicycle fork is arranged below the fork crown.

9. The double bridge bicycle fork of claim 8, wherein the brake unit comprises two brake arms arranged within the fork legs and/or the fork crown.

10. The double bridge bicycle fork of claim 9, wherein the brake arms are supported on pivot axes arranged within the fork legs and/or the fork crown.

11. The double bridge bicycle fork of claim 2, wherein the fork legs have a length-to-width ratio of at most 3:1 in the region of the lower ends of the brake arms.
